(19) United States
(12) Patent Application Publication
(10) Pub. No.: US 2008/0105473 A1
(43) Pub. Date: May 8, 2008

(54) Motorized monowheel

(76) Inventor: Whitney Jacob LuBean, North Plains, OR (US)

Correspondence Address: BIRCH STEWART KOLASCH & BIRCH, PO BOX 747, FALLS CHURCH, VA, 22040-0747, US

(21) Appl. No.: 11/593,558

(22) Filed: Nov. 7, 2006

(51) Int. Cl. B60B 19/12

(52) U.S. Cl. 180/20

(57) ABSTRACT

A motorized monowheel, comprising a wheel, an inner frame, a plurality of roller, a propelling device, and a deck. The wheel comprises a tire and an outer frame. An inner frame is set with proximity to said wheel, with a plurality of rollers located between the wheel and inner frame. The propelling device is mounted on the inner frame and connected with wheel, so as to drive the wheel to conduct rotation. The deck is mounted on the inner frame.

### BACKGROUND OF THE INVENTION

1. Field of the Invention

The present invention relates to a kind of monowheel, and more particularly, a kind of motor-powered monowheel.

2. Description of the Related Art

Ever since the 1980s, numerous types of monowheels have been disclosed in related studies or to the market. Due to the maturity of motor power technologies, speed and convenience of motorized monowheels are now further enhanced by the integration of traditional monocycles and motor power.

Motorized monowheels of this nature indeed lead to great handiness. However, as the rider sits on the seat inside the wheel, the wheel itself becomes a blockage against rider's vision; such interference increases with the width of wheel.

In addition, as the motorized monowheel proceeds, any attempt to achieve brakeage or slowdown of the machine would cause portions inside the wheel (the seat and motor in particular) to rotate back and forth to a certain degree to. Such gerbilling would very often incur discomfort to the rider.

The motorized monowheel of prior art suffers not only from the afore-mentioned concerns but also oversimplified design. In light of this, the present invention aims to provide a kind of motorized monowheel that not only solve problems confronting the prior arts but also achieves multifunctionality.

### SUMMARY OF THE INVENTION

It is an object of the present invention to provide a multifunctional motorized monowheel.

It is another object of the present invention to provide a motorized monowheel that reduces interference on the rider's vision.

It is yet another object of the present invention to provide a motorized monowheel that mends the gerbilling as braking is activated or speed of the vehicle reduces.

It is still another object of the present invention to provide a kind of motorized monowheel that facilitates practicing for the development of balance and turning principles on skateboard, surfboard, or windsurfer.

It is another object of the present invention to provide a kind of motorized monowheel that may carry two riders simultaneously.

The present invention relates to a kind of motorized monowheel that comprises a wheel, an inner frame, a plurality of roller, a propelling device, and a deck. Said wheel comprises a tire and an outer frame. Said inner frame is set with proximity to the wheel. A plurality of rollers is set between the wheel and inner frame. The propelling device is fixed on the inner frame and connected with the wheel, so as to drive the wheel to conduct rotation. The deck is mounted on the inner frame.

Other objects, advantages, and novel features of the present invention will become more apparent from the following detailed description of the preferred embodiments when taken in conjunction with the accompanying drawings.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1-a is the side view of motorized monowheel in the present invention;

FIG. 1-b is the top view of the motorized monowheel in FIG. 1-a;

FIG. 2 illustrates the relation between the roller, outer frame, and inner frame;

FIG. 3-a is the side view of kickstands fixed onto the deck;

FIG. 3-b is the front view of FIG. 3a; and

FIG. 4 illustrates the propelling device of the present invention.

### Symbol Definition.

| | |
|---|---|
| motorized monowheel: 10 | wheel: 11 |
| tire: 111 | outer frame: 112 |
| inner frame: 13 | roller: 14 |
| propelling device: 15 | drive motor: 151 |
| pulley set: 152 | driving wheel: 153 |
| first pulley: 152b | second pulley: 152c |
| belt: 152d | power source: 154 |
| roller base: 16 | pedestal: 161 |
| wing: 162 | bearing: 163 |
| bolt: 164 | screw nut: 165 |
| deck: 17 | handle: 19 |
| kickstands: 21 | shield: 23 |
| mounting area: 231 | defense: 232 |
| first control unit: 27 | second control unit: 29 |
| stirrup: 33 | spring device: 21a |
| lighting device: 35 | orifice: 18 |

### DETAILED DESCRIPTION OF THE PREFERRED EMBODIMENTS

A preferred embodiment of a motorized monowheel according to the present invention will now be described with reference to the accompanying drawings. The matters defined in the description such as a detailed construction and elements are not more than providing to assist in a comprehensive understanding of the invention. Thus, it is apparent that the present invention can be carried out without those defined matters. Also, well-known functions or constructions are not described in detail since they would obscure the invention in unnecessary detail.

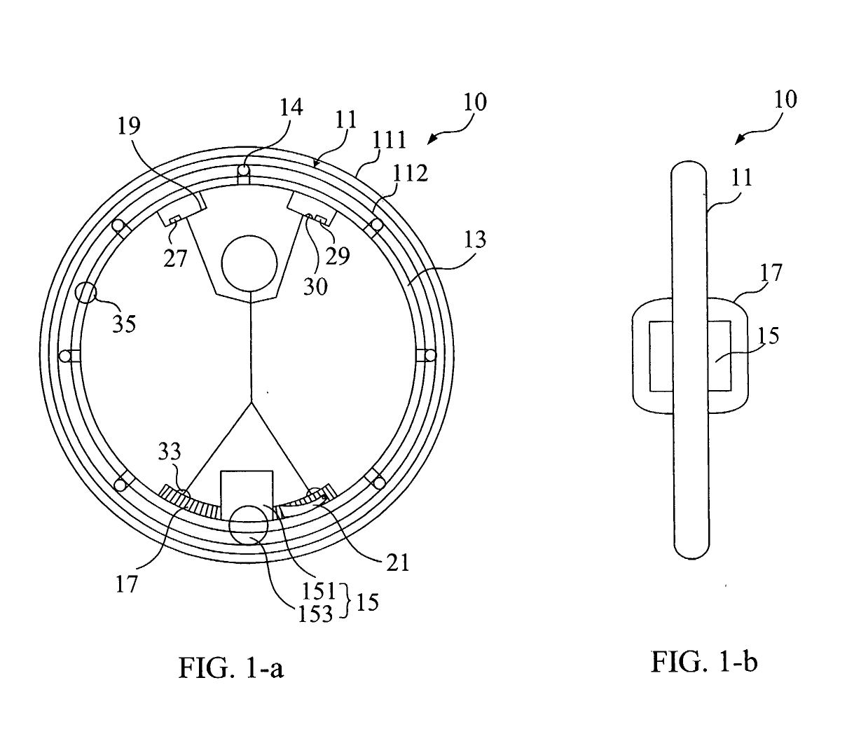

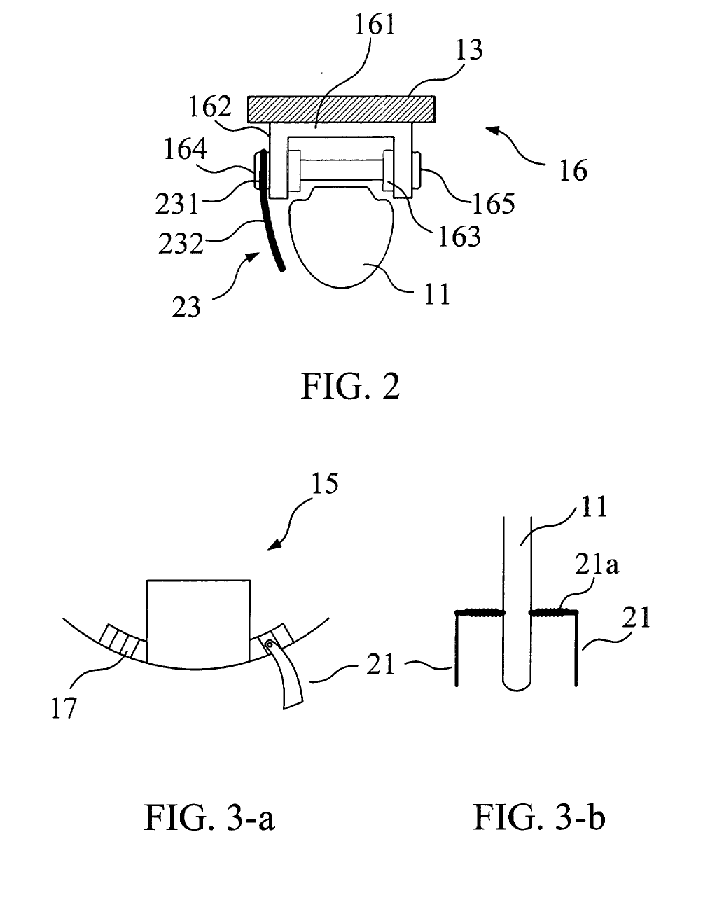

FIG. 1-a is a drawing showing the side view of the motorized monowheel 10 in the present invention; FIG. 1-b shows the top view of motorized monowheel 10 in FIG. 1-a. As shown in FIG. 1-a, the motorized monowheel 10 in the present invention includes a wheel 11, a inner frame 13, a plurality of roller 14, a propelling device 15, a deck 17, two handles 19, two kickstands 21, and a shield 23 (Note: Shield 23 is not illustrated in FIG. 1-a and 1-b but specified in FIG. 2). Said wheel 11 comprises a tire 111 that contacts the ground and an outer frame 112 that supports said tire 111. The inner frame 13 is set with proximity to wheel 11; in this embodiment, the inner frame 13 is formed as a circle with a diameter slightly smaller than that of the outer frame 112 and disposed adjacently inside the outer frame 112. In addition, the inner frame 13 can also be set with proximity to either side to the wheel 11 or adjusted in terms of configuration and diameter to meet practical demands.

In addition, a plurality of rollers 14 are disposed between the outer frame 112 and inner frame 13 and evenly distributed along the inner rim of the outer frame 112. The interrelation of motions among the roller 14, outer frame 112, and inner frame 13 can be further referred to FIG. 2. In order to ensure proportionate distribution of the rollers 14 along the inner rim of the outer frame 112, the inner frame 13 further comprises a plurality of roller bases 16. Said roller bases 16 (generally formed in a shape) comprise a pedestal 161, two wings 162, two holes on both wings (not illustrated), two bearings 163 fixed inside the two wings 162, a bolt 164 (that penetrates through the two bearings 163, said two holes, the roller 14, and the two wings 162), and a screw nut 165 that secures the bolt 164 on the two wings 162. Thus, by the above mechanism of the roller base 16, rollers 14 can be installed between the outer frame 112 and the inner frame 13 in an even distribution along the inside of the outer frame 112.

Besides, the inner frame 13 is attached with deck 17, which covers a portion of the inside of inner frame 13 and extends outward along both edges of said inner frame 13. Thus, either a rider stands on one side of the deck 17 (that is, operation by single rider) or two riders stand on each side of the deck 17 simultaneously (that is, operation by two riders facing each other). The configuration, length, width, and thickness of the deck 17 may share similarities with decks of skateboard, surfboard, or windsurfer.

Further, two handles 19 are attached to the inside (or both edges) of the inner frame 13, opposite to the deck 17. Thus, the first rider may stand on the deck 17 and hold the two handles 19 above. Afterwards, as the second rider steps onto the deck 17, the aforementioned two handles 19 are still available. Moreover, another two handles (not illustrated) can be installed inside the inner frame (or either edge of the inner frame) for the other rider to gripe. Further, the present invention may also work with only one handle (not illustrated) that can either be held by both hands of one rider or griped by the four hands of two riders.

As shown in FIG. 2, shield 23 comprises a mounting area 231 and a defense 232. The mounting area 231 is secured by the bolt 164 and screw nut 165 on one of the two wings 162 of the roller base 16, which is affixed onto the inner frame 13. Said defense 232 covers a certain portion of the flank of the wheel 11, so that even if the rider's feet step outside the deck 17, contact with the rolling wheel 11 or any associated injury would be prevented. In addition to the two wings 162 of the roller base 16, said shield 23 can also be attached, but not confined, to both side-rims of the inner frame 13. Any shield that performs the aforementioned protection and encloses any portion of the flank of the wheel can be regarded as variations of the present invention.

Please refer to FIG. 3a and FIG. 3b. FIG. 3a is the side view of kickstands 21 installed on deck 17, while FIG. 3b is the front view of FIG. 3a. The two kickstands 21 are respectively fixed on both sides of the deck 17; thus, two kickstands 21, along with the wheel 11, may constitute at least three supporting points. Consequently, when not employed, the motorized monowheel 10 may be parked vertically. When motorized monowheel 10 is used, the spring device 21 a affixed between the kickstands 21 and deck 17 can be employed to rest the kickstands 21 to both flanks of deck 17.

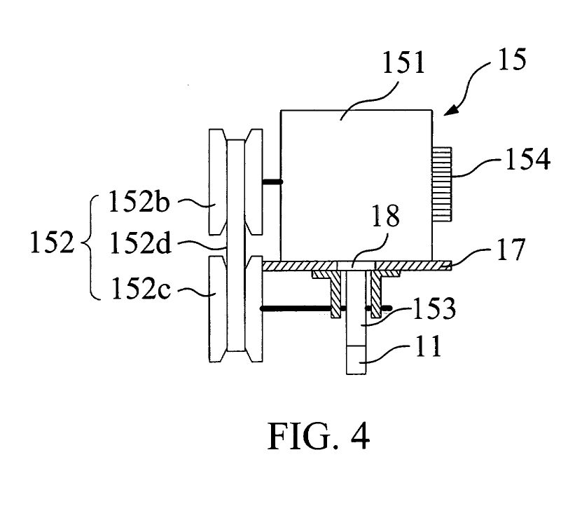

FIG. 4 illustrates the propelling device 15 in the present invention. The propelling device 15comprises a drive motor 151, a pulley set 152, and a driving wheel 153. Drive motor 151 propels the pulley set 152, whose rotation further leads the driving wheel 153 to revolve. In this embodiment, the driving wheel 153 penetrates through an orifice 18 on the inner frame 13, so as to contact with wheel 11. In this manner, driving wheel 153 directly drives the wheel 11 to rotate.

Here, said pulley set comprises a first pulley 152b, a second pulley 152c, and a belt 152d. The first pulley 152b is connected with the drive motor 151, while the second pulley 152c is connected with the driving wheel 153; meanwhile, both first pulley 152b and second pulley 152c are meshed by the belt 152d.

Also, the propelling device 15 further comprises one power source 154 that supplies energy to the propelling device 15. In this embodiment, the power source 154 can be onboard rechargeable batteries or fuel cells, and the drive motor 151 is facilitated by a DC motor. As power source 154 feeds more intense current, operation of the DC motor accelerates. By this procedure, the motorized monowheel 10 of the present invention features speed changing functionality. As power source 154 feeds a counter current to DC motor, the DC motor reverses, so as to reduce the moving speed or stall the operation (or even drive the motor-powered monowheel 10 to move on the opposite direction). Namely, when power source 154 intensifies the feeding current, the speed-changing functionality is actuated; while the power source 154 feeds a counter current, the braking functionality would be activated.

Please refer to FIG. 1-a. In order to provide the rider with aforementioned speed-changing functionality, the present invention further comprises a first control unit 27. In this embodiment, the first control unit 27 is mounted on the handles 19 and coupled to the power source 154. Other embodiments may have the first control unit 27 installed on the inner frame 13 or deck 17 and coupled to the power source. Via the first control unit 27, current fed from the power source to the propelling device 15 can be intensified, so as to raise the rotation speed of propelling device 15. Here, said first control unit 27 facilitated by forms of hand grip, twist grip, or foot lever.

In order to allow the rider to adjust said braking function, the present invention further comprises a second control unit 29. In this embodiment, second control unit 29 is installed on the handles 19 and coupled to power source. In addition, second control unit 29 can also be set on the inner frame 13 or deck 17 and coupled to power source. Via second control unit 29, a counter current can be fed from the power source to the propelling device 15, so as to reduce the rotation speed of propelling device 15. Here, said second control unit 29 can be facilitated by hand grip, twist grip, or foot lever.

Also, it is worth mentioning that, since the motorized monowheel 10 of the present invention employs electric motor as the power source and onboard rechargeable batteries to store energy, when speed of the motorized monowheel 10 is reduced, the motor may be transformed into a generator that converts energy into electricity, which is fed back to the rechargeable batteries. Subsequently, recycled electricity can be stored in the onboard rechargeable batteries, so as to reduce waste of energy. The above procedure that transfers excessive energy derived during braking into backup system is referred as regenerative braking.

In addition to onboard rechargeable batteries and fuel cells, the abovementioned power source 154 can also be facilitated, but not limited, to gas engines and diesel engines. In cases of gas engine or diesel engine, a braking device can be installed inside the propelling device, such that a braking system can be realized. Moreover, variable gears can also be incorporated in the propelling device on the purpose achieve speed-changing functionality. Notice that, the aforementioned measures to implement power source, brake, regenerative braking, and speed-changing devices are not confined to said examples; any design that achieves said functionalities of power source, brake, regenerative braking and speed changing can be applied to motorized monowheel 110 of the present invention.

In another embodiment of the present invention, the motorized monowheel 10 further comprise stirrup 33, and lighting device 35. The stirrup 33 is screwed on deck 17 to ensure stability of the rider who stands on the deck 17. The present invention further provides a lighting device 35 to facilitate riding when rider's eyesight is hazed (such as in cases of nighttime, fog, or rain). In addition, the present further at least comprises a long vertical handles(not illustrated), set on either side of the deck extending all the way to the top, for added control.

In order to prevent the propelling device 15 from continuous operation once the rider is detached from the motorized monowheel 10, the present invention further comprises a braking device (not illustrated). The braking device comprises a touch unit 30, which is coupled to the power source; when touch unit 30 send a signal to power source, power source stops feeding energy to the propelling device 15, so as to cease the motorized monowheel 10 from operation. Said touch unit 30 can be set on the deck 17 or the handles 19 (as in this embodiment). When the rider stands on the deck 17 or gripes the handles 19 (that is, the aforementioned touch unit 30 is pressed), the touch unit 30 does not transmit signal to the power source, so that the propelling device 15 remains operating. When the rider is not standing on the deck 17 or griping the handles 19 (that is, the aforementioned touch unit 30 is not pressed), the touch unit 30 would transmit signals to power source, so that operation of propelling device 15 is discontinued. Thus, when the present invention of motorized monowheel 10 is not employed (that is, the rider is not standing on the deck 17 or griping the handles 19), or the rider is detached from the motorized monowheel 10 during cruise (that is, the rider is not standing on the deck 17 or griping the handles 19), propelling device 15 of the motorized monowheel 10 would be automatically deactivated to avoid damage to the vehicle or injury to the rider.

The motorized monowheel 10 of the present invention allows the adjustment of center of gravity by the rider who stands on the deck 17 to change the moving direction of the motor-powered monowheel, a principle shared by windsurfing, surfing, and skateboarding. Moreover, with similar operation principles, the motorized monowheel 10 of the present invention can also be applied to practice skills on windsurfer, surfboard, or skateboard. Component dimensions of the present invention motorized monowheel are as follows. In case of designs for adults, the wheel may have an outer diameter of 80 inches, an inner diameter of 72 inches, a wheel width of 3 inches, and a tire thickness of 3 inches; the inner frame may have a diameter of 71 inches; the deck 17 may have a length of and 36 inches and a width of 12 inches; the propelling device may be given 12 inches in length, width, and height; and the propelling device may feature a horse power ranging between 4.5 HP and 9 HP.

For the case of designs for young adults, the wheel may feature an outer diameter of 66 inches, an inner diameter of 60 inches, a width of 3 inches, and a tire thickness of 3 inches; the inner frame has a diameter of 59 inches; the deck is 30 inches in length and 10 inches in width; and the propelling device may be 10 inches in length, width, and height, with a horse power ranging between 1.5 HP and 3.5 HP.

It is worth mentioning that, component dimensions of motorized monowheel in the present invention is exemplified but not limited in the aforementioned embodiment. Variations may be made in response to rider's demand, experience, height, and preference. Moreover, the design of elements (tire width, tire thickness, and tread in particular) may be modified to adapt to various types of grounds or terrains, such as sand, dirt, pavement, snow, and grass.

As is apparent from the foregoing, motorized monowheel of the present invention features the following advantages. (1) Since the riders are allowed to stand on either side of the deck, interference to their vision is reduced. (2) Motorized monowheel of the present invention allows the adjustment of center of gravity by rider who stands on the deck to change the moving direction of the motorized monowheel. Due to similar balancing and turning principles shared with skateboarding, surfboarding, and windsurfing, skills for these sports can be effectively developed by practicing on the motorized monowheel. (3) When braking is activated, the rider who stands on the deck of motor-powered monowheel of the present invention may achieve balance control by efficient absorbing gerbilling and thus greatly reduce the discomfort encountered with prior arts. (4) The present invention has the deck mounted on the wheel and extend outward along the two edges, so that the monowheel can be used by either one or two riders.

Therefore, the present invention discloses a motorized monowheel that not only amends issues concerning interference on sight and gerbilling but also provides multifunctionality for practice (as mentioned in the above second point) and fun (as mentioned in the above fourth and fifth points).

Although the invention has been explained in relation to its preferred embodiment, it is to be understood that many other possible modifications and variations can be made without departing from the spirit and scope of the invention as hereinafter claimed. Further, the present invention is defined by the patent claims.

What is claimed is:

1. A motorized monowheel, comprising:
a wheel, incorporated by a tire and an outer frame;
an inner frame, set with proximity to said wheel;
a plurality of rollers, which are installed between said wheel and said inner frame;
a propelling device, which is mounted on said inner frame and connected with said wheel to drive said wheel to rotate; and
a deck, which is mounted on said inner frame.

2. The motorized monowheel as claimed in claim 1, wherein the inner frame is a circle.

3. The motorized monowheel as claimed in claim 2, wherein the outer frame has a diameter slightly larger than that of said inner frame.

4. The motorized monowheel as claimed in claim 1, further comprises at least one handle, installed onto said inner frame.

5. The motorized monowheel as claimed in claim 1, further comprises two handles, installed onto said inner frame, and each handle can be griped by one hand.

6. The motorized monowheel as claimed in claim 1, wherein the deck is mounted along a certain portion of the inside of said inner frame and extend outward along two edges of said inner frame.

7. The motorized monowheel as claimed in claim 1, wherein the inner frame further comprises:
a plurality of roller bases, which are screwed on said inner frame and generally formed in the shape of, comprising two wings and a pedestal fixed on said inner frame;
two bearings, respectively attached to said two wings;
a roller shaft, which is linked to said roller, with each of both ends mounted on said two bearings.

8. The motorized monowheel as claimed in claim 1, further comprising a shield that is composed of a mounting area fixed on said inner frame and a defense enclosing part of the flank of said wheel.

9. The motorized monowheel as claimed in claim 1, further comprises
two kickstands, which are respectively installed onto the two flanks of said deck and enable said motorized monowheel to rest erectly.

10. The motorized monowheel as claimed in claim 1, wherein the propelling device comprises:
a drive motor; and
a driving wheel, which is connected with said drive motor and contacts said wheel,
therefore, said driving wheel may drive said wheel to rotate accordingly.

11. The motorized monowheel as claimed in claim 10, wherein the propelling device further comprises a pulley set, said pulley set comprises:
a first pulley, which is connected with said drive motor;
a second pulley, which is connected with said driving wheel; and
a belt, meshing said first pulley and second pulley.

12. The motorized monowheel as claimed in claim 10, wherein the propelling device further comprises a power source to feed energy to said propelling device, whether facilitated by onboard rechargeable batteries, fuel cell, gas engine, or diesel engine.

13. The motorized monowheel as claimed in claim 12, wherein a control unit is mounted on said inner frame, said deck or said handles and coupled to said power source, so as to modulate energy fed from said power source to said propelling device and further adjust the rotation speed of said propelling device.

14. The motorized monowheel as claimed in claim 13, wherein the control unit can be hand grip, twist grip or foot lever.

15. The motorized monowheel as claimed in claim 10, further comprises a braking system, said braking system comprises:
a braking component, mounted on said inner frame, said deck, or said handles, and coupled to said drive motor, wherein the braking component may drive a reverse current to said drive motor.
